(19) United States
(12) Patent Application Publication
(10) Pub. No.: US 2012/0091843 A1
(43) Pub. Date: Apr. 19, 2012

(54) ELECTRICITY GENERATED OFF RECURRING ENERGY

(76) Inventor: Richard G. Gore, Jupiter, FL (US)

(21) Appl. No.: 13/129,851

(22) PCT Filed: Nov. 20, 2009
(86) PCT No.: PCT/US09/65372

§ 371 Date: Jan. 3, 2012

Related U.S. Application Data
(60) Provisional application No. 61/116,687, filed on Nov. 21, 2008.

(51) Int. Cl. H02K 47/00; H02K 53/00

(52) U.S. Cl. 310/113; 74/DIG. 9

(57) ABSTRACT

The ELECTRICITY GENERATED OFF RECURRING ENERGY (EGORE) unit is a self-contained system that produces electricity at continuous voltage loads without the need of external fuel or additives. EGORE coverts electricity into mechanical energy, amplifies the mechanical energy, and reconverts mechanical energy into electricity. The amplification produces a greater amount of electricity than is required to power the unit; the excess power is stored for external use in a capacitor. EGORE when necessary utilizes a unique inner cooling process that optimizes performance to achieve larger voltage demands. EGORE is modifiable to fulfill small portability needs and achieving all voltage demands. EGORE can be adapted to utilize external cooling and capacitor use with minimal energy losses.

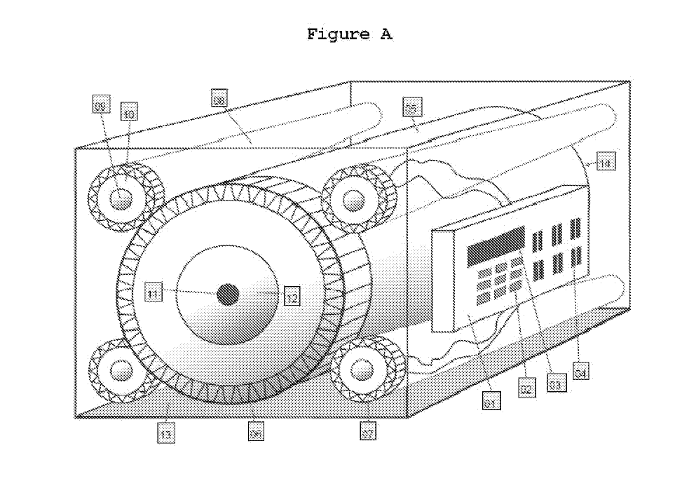

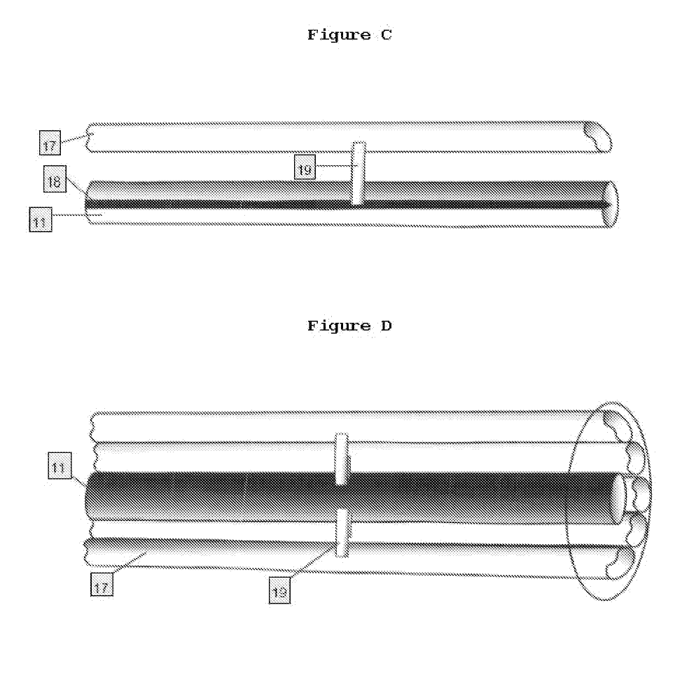

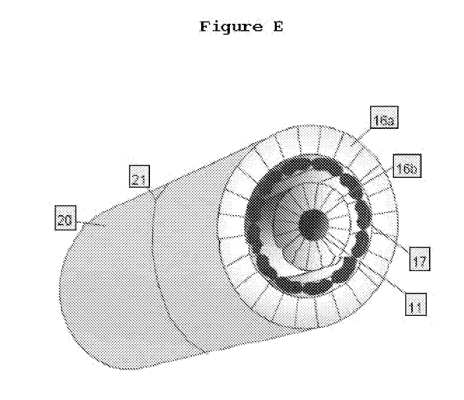

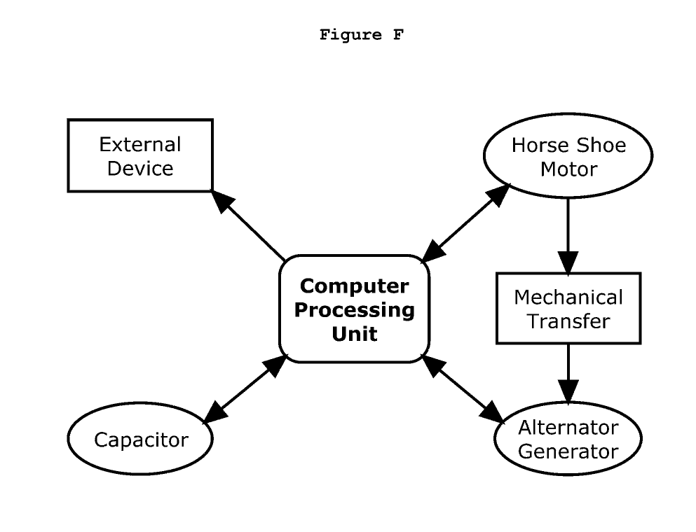

### BACKGROUND OF THE INVENTION

1. Field of Invention

The present invention relates to an electricity generating system.

2. Background of the Invention

Electricity generating systems require the conversion of mechanical or chemical energy into electrical energy. The conversion may be created through magnetic induction. Magnetic induction involves the interaction of one magnetic field with another. The fixed magnetic polarity of a stator creates force within the armature of a power generator or alternator causing the movement of electrons. The induction occurs quickly but must be reproduced in opposite or alternating currents to generate electricity. To accomplish this feat the armature must rotate inside the stator at high speeds. The mechanical movement is propelled by an external source. The external force has historically been water (dam), wind (windmill), heat/nuclear (steam turbine) or fuel (combustion). These alternator/generators can only utilize external cooling.

There have been attempts to utilize motors to power equivalent sized generator/alternators to reproduce more power than is lost. For example, U.S. Pat. No. 7,095,126 to McQueen describes an internal energy generating power source. An external power source such as a battery is used to initially supply power to start an alternator and generator. The alternator supplies power to a number of invertors which output part of the energy to the generator and part to a load device.

U.S. patent application Ser. No. 10/688,477 to Foster describes a self-powered electrical generator which utilizes motors and “power-converters” to upregulate voltage—although the workings of the power converter are not described.

U.S. patent application Ser. No. 10/414,339 to Patching describes an “electronic perpetual engine”. While the specification describes energy generation utilizing a motor, battery, dynamo, large gear, small gear, and magnets, the system does not describe the use of a capacitor or of specially designed magnets.

U.S. patent application Ser. No. 10/772,346 to Ellison describes a “perpetual motion energy” machine which recharges batteries utilizing a generator.

Finally, U.S. patent application Ser. No. 11/037,947 to Shirlee describes a “self powered electrical system” comprising a battery, motors, generators, and gears. The system does not utilize a capacitor or specially adapted magnets.

These methods provide insufficient power levels, thereby making the self-described energy sources fail for their intended purpose. The torque to induction ratio of a motor and alternator/generator can be exactly one-to-one, but the loss incurred from the resistance of the gears, chain or belt will cause a deficiency in the regenerated power. The system can be altered into a one-to-two ratio. This can create excess torque for the motor resulting in a higher power draw. If the alternator/generator rotates faster than the energy recapture is calculated for, it will become ineffective per design.

Heat is a common byproduct resulting from the use of electricity. To run a looped electrical system without the use of cooling will create numerous problems in the mechanical parts. External cooling can be used but the operating system has to be engineered for fluid interaction. Examples of external cooling include a car radiator for an engine, ocean water cooling for nuclear, or air conditioning condensers. Alternatively, electricity can be generated from wind which process produces low heat levels. The greatest difference between an electric motor and an alternator/generator is that the recapture of electrons (by an alternator/generator) generates less semiconductor heat than the push of electrons for movement (as in a motor).

### SUMMARY OF THE INVENTION

The present invention, in any one or more embodiments, may be identified as the “EGORE” (electricity generated off recurring energy) device. EGORE's primary components comprise the electrical alternator/generator, aluminum alloy gears, capacitor and onboard computer. Additional novel components include a “Stator Motor” with an “Inner Cooling System”. As one embodiment, the stator motor is a six-sided device. When combined according to the present invention, the device becomes a self powered electricity producing system with an integrated cooling system.

EGORE is an energy system that operates from its own regenerated power; no external source of energy or fuel is required for operation. EGORE does not require any outside source for cooling, but adaptations could include external cooling devices. EGORE simultaneously powers/cools itself and produces extra electricity at continuous levels to power external devices.

The EGORE unit can be manufactured in a variety of sizes depending on the external energy demand. EGORE can produce 1 volt or millions of volts at an unending rate. EGORE can, in one or more embodiments, satisfy the energy demands of human society. As can be appreciated by the foregoing, EGORE has application to any energy consuming process or device such as, without limitation, computers, both portable and stationary, camcorders, digital cameras, digital picture frames, digital scanners or photo copiers, printers, projector, LCD/Plasma televisions, universal remote, DVD/BLURAY players, digital video recorder, navigation units, house/work/cellular telephone, portable music players, PDA's, Satellite radio, hand held/house gaming systems, children's toys/games, vibrating toothbrush, air purifier, handheld power tools, every household appliance or the entire house with one larger unit, lawn devices and equipment, office or entire buildings: apartments, malls, hospitals, government, airports, airplanes electrical and A/C systems, fresh and salt water boats/submarines, industrial uses are desalinization plants, food processing plants and farm equipment, any manufacturing operations, electrical scooters/bikes/mopeds/motorcycle, cars, trucks, SUVs, campers, busses, 18 wheelers, tanks or military grade vehicles, hovercraft, trains/subway/trolley, propeller planes, helicopters, and with gravity free operation EGORE can power space craft, space stations and lunar or other bases.

### BRIEF DESCRIPTION OF THE DRAWINGS

FIG. A: This rendering has a translucent shell showing the Gears, Stator Motor such as a six-sided stator motor, Alternators and Exterior Computer Display with Plugs.

FIG. B: This rendering is an aerial image with the Stator Motor, such as the six-sided stator motor, open and cooling system exposed. Gears and Alternator are shown.

FIG. C: This is one magnetic armature of the series.

FIG. D: This is how the armatures align before entering the six-sided stator.

FIG. E: This picture has the end cap removed to show the magnetic armature inside the stator field.

FIG. F: This diagram illustrates schematically the general method of operation of one exemplary embodiment of the present invention.

### BRIEF DESCRIPTION OF REFERENCE NUMERALS

Central Processing Unit (1); External Key Pad (2); Display Screen (3); Standard US Outlets (4); Motor (such as a six-sided stator motor) (5); Greater Alloy Gear (6); Lesser Alloy Gear (7); Alternator or Generator (8); Alternator or Generator Stabilizing Commutator (9); Stabilizing Rod End Point Casing (10); Horse Shoe Motor Stabilizing Commutator (11); Central Stabilizing Rod End Point Casing (12); Exterior Housing (13); Inner Cooling System Turbine (14); Cooling and Lubricating Fluid (15); Stator motor such as a six-sided stator motor (16); Exterior Stator (16a); Interior Stator (16b); Electromagnetic unit known as Armature (17); Conducting Strip for the Electromagnet (18); Delivery and Brace (19); Exterior Motor Housing (20); and Cooling System Out Flow (21)

### DETAILED DESCRIPTION OF THE PREFERRED EMBODIMENT

One object of this invention is to create electricity through an unbalanced energy use to energy regeneration process. EGORE uses less energy than it creates. EGORE generates electricity from magnetic induction. It also expends energy from magnetic induction. EGORE regenerates greater magnetic induction loads than it expends; consequently the excess energy/electricity is continuously available.

ACTIVATION: EGORE will need to be jumpstarted only once for it to work continuously. After the external charge has been delivered into the Outlets (4), the CPU (1) will initiate the start program making the Stator Motor such as the six-sided stator motor (5) turn the Greater alloy gear (6). The CPU (1) comprises a mother board, circuiting processors, data ports, external computer link, diodes and at least one capacitor. The external key pad (2) allows personal security codes, command functions, scrolling, and power down functions. Display screen (3) is adapted to show monitored results and additional settings menus.

The Greater Alloy Gear (6) now turns the Lesser Alloy Gear (7) at a faster rotation. The Lesser alloy gear (7) rotates the Alternator or Generator armature. The Alternators or Generators (8) are turned by the Stator Motor (5) as the speed increases so that the torque levels drop; energy is saved when larger gear ratios are applied. The Alternators or Generators (8) convey electricity into the CPU (1) which stores the energy in a capacitor. EGORE has now had its first energy cycle and the external source of energy is removed.

ACTIVATED: EGORE is now running at a continuous rate. Electricity levels are at stable range and external devices or items can now be attached for use. During this stage of operation, the CPU (1) takes electricity from the energized capacitor and delivers it to the Stator Motor such as the six-sided stator motor (5) which rotates an Armature (17) through a process called reverse induction (applying a North polarity to a North polarity for detraction); respectively, the same happens for the Southern polarity.

The Stator Motor such as the six-sided stator motor (5) is novel because it creates reverse induction on six sides (tops, bottoms and tips) of the Armature (17), unlike conventional one surface motors. The purpose for utilizing three sides is intended for torque. Torque is the resistance created by forcing the Gears (6, 7) and Alternators or Generators (8) to turn. The Horse Shoe Motor's (5) required energy consumption is about half the power-to-torque ratio than conventional motors. This optimization enables EGORE to work efficiently at turning the Greater alloy gear (6) which may be 5 times larger than the Lesser alloy gear (7). The exact gear ratio can be adapted depending on need.

The Lesser alloy gear (7) spins at a faster rate than the Greater alloy gear (6). This faster rate of rotation directly aligns with the armature of the Alternators or Generators (8). The Alternators or Generators (8) are smaller than the six-sided Stator Motor (5), but more abundant.

Induction is more difficult as compared to reverse induction or simply stated, it is harder to recapture energy than to use it. The Alternators or Generators (8) harness the magnetic polarity given off by a stator as it alternates to the polarity of the internal armature. This alternating of North and South polarity will create current having a certain frequency which will be transferred through the CPU (1) into the capacitor.

The capacitor then stores the highest frequency of the four (or more) Alternators or Generators (8) so that distribution of lower or average electrical frequency requirements are possible. Batteries are incapable of this action and are not used in any EGORE unit. The capacitor is either stored inside the EGORE casing or routed externally to another capacitor; the purpose being that the large electricity requirement is produced by linking several EGORE's into a very large capacitor. Estimations that 40% or less of the electricity of the cycle is returned back into the system by the CPU (1); the remaining 60% or more is free to use externally; this changes with each six. The use of a larger external capacitor would allow for multiple EGORE inputs resulting in larger Ampere pushes from the system, thereby allowing, e.g., millions of volts to be produced.

EGORE will maintain this cycle uninterrupted for the life of any one component. EGORE's construction is comprised of metal and alloy which have long life spans. The CPU (1) with require silicon, plastic and rubber byproducts that will deteriorate over time. EGORE recognizes this problem and isolates the CPU (1) from the core housing so swap outs can be performed. The unit can achieve 100+ years of operation exempting the CPU (1) which could have an average operating life of about 25 years.

COOLING SYSTEM: EGORE has employed a intelligent method for internal cooling. The addition of external cooling devices or pumps to EGORE would place extra electrical draw on the system. To maximize efficiency, EGORE attaches the Horse Shoe Motor stabilizing rod (11) to the Inner Cooling System Turbine (14).

When the Electromagnetic Armature (17) makes one rotation, the Inner Cooling System Turbine (14) rotates thereby pushing the Cooling and Lubricating Fluid (15) into the Stator Motor such as the six-sided stator motor (5). The Cooling and Lubricating Fluid (15) then exits thru a Cooling System Out-Flow (21). The Cooling and Lubricating Fluid (15) fills the entire EGORE unit; no air is allowed inside the container. The Cooling and Lubricating Fluid (15) is taken back through one or more straw like tubes that run along the surface of EGORE's Exterior Housing (13).

### OPERATION OF THE INVENTION

The Central Processing Unit (1) contains a mother board, circuiting processors, data ports, external computer link, diodes and capacitor (or capacitors). The CPU (1) releases electricity to the Stator Motor such as the six-sided stator motor (5) and receives electricity from the Alternator or Generator (8). The CPU (1) continuously monitors the capacitor energy levels and electricity draw/demand of external devices or products. The CPU (1) regulates the temperature of EGORE. The CPU (1) delivers the current changes into the Stator Motor such as a six-sided stator motor (5) for operation. The CPU (1) deciphers the alternating frequencies of the Alternator or Generator (8). The CPU (1) has an interface for external computer communication.

The External Keypad (2) allows personal security codes, command functions, scrolling, and powering down. The keypad is the only external moving part. Display screen (3) is used to show monitored results and additional settings menus. This is the basic human interface with the EGORE unit showing relevant information. Attaching an external computer will give more comprehensive data.

Standard US Outlets (4) supplying 120 Volts are provided. Other embodiments of EGORE can use adapted plugs per voltage demand and in some cases a hard line will be directly attached. EGORE is engineered for multiple uses and productions.

The novel Stator Motor such as the six-sided stator motor (5) does not exist in the market place today. Its unique design goes beyond the normal electromagnetic interaction. The Horse Shoe Stator wraps around three sides of the Electromagnetic Armature (17). The excess surface area of the Electromagnetic Armature (17) produces more powerful induction levels which amount to better torque management. For example, conventional electric motors will have an armature wedge with dimensions of one inch long by one half inch high by one eighth inch wide or 1″×½″×⅛″. The result is that only the 1″×⅛″ side (1.125 square inches) is an induction surface area; the rest is wasted.

EGORE takes the same wedge dimensions and uses two sets of three sides (or North polarity ½″×⅛″+½″×⅛″+ 3/7″× 1/9″ and South polarity ½″×⅛″+½″×⅛″+ 3/7″× 1/9″=3.54 square inches per wedge) Being like a bar magnet, the conventional motor access having one side being either North or South. The Horse Shoe Motor (5) engages both the North and South Side of the magnet every time. Greater alloy gear (6) has a center attachment for the stabilizing rod and rotates in one direction. Lesser alloy gear (7) has a center attachment for the stabilizing rod and rotates in one direction.

Alternator or Generator (8) comprises a winding coil of wire around an iron core thereby providing a magnet. If a magnet is passed near a wire, an induced current will flow in that wire. If many magnets are rapidly passed over a coil of wire, much more induced current will be produced. If many magnets are passed over several coils of wire, even more current will be produced. Although Alternators vary by manufacturer, there are two elements common to all alternators; the stationary stator and the rotating rotor. The stator consists of three sets of individual windings wound around a laminated circular iron stator frame. Each individual winding is made up of seven coils, which in turn are made up of several individual loops all connected in series. Each coil and each loop are connected so as to increase the total voltage output. Each group of windings has only two leads, one for current to flow in, and the other for current to flow out.

The Alternator or Generator stabilizing rod (9) extends from end to end and is intended to prevent movement of any components or gears. This also acts as the Commutator for the Armature.

Stabilizing Rod End Point Casing (10) holds the Alternator or Generator Stabilizing Rod (9) and allows for rotation to occur. Horse Shoe Motor Stabilizing Rod (11) extends from end to end and is intended to prevent movement of any components or gears. This also acts as the Commutator for the Armature.

Central Stabilizing Rod End Point Casing (12) holds the Horse Shoe Motor stabilizing Rod (11) and allows for rotation to occur.

Exterior Housing (13) keeps the interior contents protected. Inner Cooling System (14) removes heat through conveyance. The heat is then released into the external air space outside the unit. Cooling and Lubricating Fluid (15) acts much like radiator fluid would with the addition of synthetics for moving parts friction reduction.

Horse Shoe Stator (16) is a two piece unit that is placed on either end of the Electromagnetic Armature (17). The stator encompasses three sides of the armature as shown in FIG. B. Electromagnetic unit (17) known as Armature acts the same as a bar earth magnet having definable North and South poles. The electrical current determines each in the series. This is delivered through the commutator.

Conducting Strip (18) for the Electromagnet is the pathway through which electricity is delivered from a brush into the coils of the Armature (17). Delivery and Brace (19) are the pathway thru which electricity flows from Conducting Strip (18) to Armature (17). This part must also handle the torque being delivered.

Exterior Motor housing (20) surrounds the Horse Shoe Stator (16) and links them together. Cooling System (21) Out Flow contains vents in the Exterior Motor (20) Housing that allow out flow of the Cooling and Lubricating Fluid (15).

### CONCLUSION

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

1. A system for generating energy such that a portion of the generated energy supplies power to the system that generated the energy comprising:
(a) a central processing unit (CPU) having at least one capacitor;
(b) at least one large gear;
(c) at least one small gear;
(d) at least one alternator;
(e) at least one generator;
(f) at least one magnet; and
(g) at least one motor;
wherein
said CPU is adapted to utilize said at least one motor to turn said at least one large gear; said at least one large gear is adapted to turn said at least one small gear at a rotation faster then said at least one large gear; said at least one small gear is adapted to rotate the armature of said at least one alternator; said alternator is adapted to convey energy to said at least one capacitor; and said CPU is further adapted to deliver energy from said at least one capacitor to said at least one motor.

2. A system for generating energy such that a portion of the generated energy supplies power to the system that generated the energy comprising a CPU which is adapted to provide power to an external device, said CPU comprising a capacitor which is charged by an alternator or generator, said alternator or generator generating electricity by induction of mechanical energy initiated by a motor; and said motor powered by said CPU.

3. The system of either one of claim 1 or claim 2 further comprising an external source of power for providing an initial charge to said system.

4. A process for generating energy such that a portion of the generated energy supplies power to the system that generated the energy comprising the steps of:
(a) providing an external source of power to a motor;
(b) driving a gear using said external source of power;
(c) driving a second gear using said gear;
(d) driving an alternator or generator by magnetic induction using said second gear;
(e) charging a capacitor using the energy generated by magnetic induction;
(f) removing the external source of power to said motor;
(g) powering said motor using the charge in said capacitor;
(h) using charge not needed to maintain the charge in said capacitor created by magnetic induction to optionally power an external device.

5. The process of claim 4 in which said gear and said second gear are not in a 1 to 1 gear ratio.

6. The system of claim 1, wherein the motor comprises a six-sided motor adapted to create induction on the tops, bottom and tips of an armature.
